(19) United States
(12) Patent Application Publication
(10) Pub. No.: US 2005/0029951 A1
(43) Pub. Date: Feb. 10, 2005

(54) Surface light source device and display apparatus having the same

(76) Inventors: Seock-Hwan Kang, Suwon-si (KR); Jong-Sun Lim, Seoul (KR)

Correspondence Address: CANTOR COLBURN LLP, 55 Griffin Road South, Bloomfield, CT, 06002, US

(21) Appl. No.: 10/805,923

(22) Filed: Mar. 22, 2004

(30) Foreign Application Priority Data
Aug. 7, 2003 (KR) 2003-54771

(51) Int. Cl. H01K 1/30; H01J 17/16; H01J 61/35

(52) U.S. Cl. 313/635; 313/489; 313/110

(57) ABSTRACT

A surface light source device includes a light source body to generate light in response to an electric signal, which has a space filled with a discharge gas to generate the light, and a light diffusion part to diffuse the light generated from the light source body to output diffused light. The light diffusion part is integrally formed with the light source body. The light source body includes a first substrate through which the diffused light is output, a second substrate disposed to face the first substrate, in which a space is formed between the first and second substrates, at least one partition disposed between the first and second substrates, in which the space is regionally divided by the at least one partition, a sealing member disposed between the first and second substrates to seal the space, and a voltage applying part to provide the electric signal to excite the discharge gas in the space.

### BACKGROUND OF THE INVENTION

1. Field of the Invention

The present invention relates to a device for providing light in image display devices, and more particularly, to a surface light source device providing light having enhanced luminance and uniform luminance distribution and to a image display apparatus employing the surface light source device.

2. Description of the Related Art

A liquid crystal display device generally includes a liquid crystal adjusting part and a light providing part. The light providing part provides light to the liquid crystal adjusting part. The liquid crystal adjusting part adjusts the optical properties of the liquid crystal so as to display images using the light provided from the light providing part.

The liquid crystal adjusting part includes pixel electrodes, a common electrode and the liquid crystal interposed between the pixel electrodes and the common electrode. The common electrode and the respective pixel electrodes are disposed facing each other. A thin film transistor (TFT) is electrically connected to a pixel electrode, and the thin film transistor operates as a switching device. A pixel voltage is applied to the pixel electrode via the thin film transistor. A reference voltage is applied to the common electrode. Thus, electric field is formed between the pixel electrode and the common electrode, so that the arrangement of the liquid crystal between the pixel electrode and the common electrode is adjusted. The pixel electrodes and the common electrode are made of electrically conductive and transparent material, such as indium tin oxide (ITO).

The light providing part provides the light to the liquid crystal adjusting part. Then the light passes through the pixel electrode, the liquid crystal and the common electrode in sequence, so that the light is transformed into image light that contains image information.

Thus, the display quality of a liquid crystal display device depends on luminance and uniformity of the light generated from the light providing part. As the luminance and the uniformity increase, the display quality is improved.

In general, a light providing part adopts a cold cathode fluorescent lamp (CCFL) or a light emitting diode (LED) and others. The cold cathode fluorescent lamp generates high luminance light, having a long lifespan, and white color. The light emitting diode also generates light with high luminance and has low power consumption.

However, the cold cathode fluorescent lamp and the light emitting diode generate non-uniform light. Thus, for using as a light source of display the cold cathode fluorescent lamp or the light emitting diode needs an additional member, such as a light guide plate, a light diffusion member, a prism sheet, etc, to generate light with uniform luminance distribution. As a result, there is an inevitable increase in volume and weight of the liquid crystal display device.

### SUMMARY OF THE INVENTION

The above disclosed and other drawbacks and deficiencies of the conventional light sources are overcome or alleviated by a surface light source device and the display apparatus employing the same according to the present invention. In one embodiment, a surface light source device includes a light source body to generate light in response to an electric signal, in which the light source body has a space filled with a discharge gas to generate the light, and a light diffusion part to diffuse the light generated from the light source body to output diffused light. The light diffusion part may be integrally formed with the light source body. The light source body may include a first substrate through which the diffused light is output, a second substrate disposed to face the first substrate, in which a space is formed between the first and second substrates, at least one partition disposed between the first and second substrates, in which the space is regionally divided by the at least one partition, a sealing member disposed between the first and second substrates to seal the space, and a voltage applying part to provide the electric signal to excite the discharge gas in the space. A fluorescent layer may be coated on the surfaces of the first and second substrates, the at least one partition and the sealing member, which define the space of the light source body.

The light diffusion part may include a light diffusion pattern formed on a surface of the first substrate to diffuse the light generated from the light source body. In an embodiment where the first substrate has first and second surfaces opposite to each other and the first surface is in contact with the space and the at least one partition, the light diffusion pattern includes a plurality of convex surfaces successively formed on the second surface.

In other embodiments, the light diffusion pattern may include a plurality of convex members formed on the second surface such that density of the convex members is higher at a first area through which the light passes than at a second area adjacent to the at least one partition; a plurality of convex members formed on the second surface such that the convex members have a larger size at an area adjacent to the at least one partition that at an area through which the light passes; a plurality of convex surfaces successively formed on the first and/or second surface; a plurality of V-shaped grooves successively formed on the second surface; a plurality of protrusion members discretely formed on the second surface, each of which has a cross-sectional view of a polygonal shape; or a plurality of grooves discretely formed on the second surface, each of which has a cross-sectional view of a polygonal shape.

In another embodiment, the light diffusion part includes a plurality of light diffusion members disposed on a surface of the first substrate through which the diffused light is output. The light diffusion members may have a substantially identical size or various sizes and are attached on the surface of the first substrate by adhesive, or have a substantially identical size and are securely held by a binder which is coated on the surface of the first substrate.

In another embodiment, a display device displaying images in response to electrical signals externally provided includes a display panel to display the images, a surface light source device to provide surface light to the display panel, in which the surface light source device includes a light source body to generate light in response to an electric signal, the light source body having a space filled with a discharge gas to generate the light, and a light diffusion part to diffuse the light generated from the light source body to output diffused light, in which the light diffusion part is integrally formed with the light source body, and a receiving container to receive and securely hold the display panel and the surface light source device.

These and other objects, features and advantages of the present invention will become apparent from the following detailed description of illustrative embodiments thereof, which is to be read in connection with the accompanying drawings.

### BRIEF DESCRIPTION OF THE DRAWINGS

This disclosure will present in detail the following description of exemplary embodiments with reference to the following figures wherein:

FIG. 1 is a perspective view illustrating a surface light source device according to an exemplary embodiment of the present invention;

FIG. 2 is a cross-sectional view of the surface light source device taken along line A-A′ in FIG. 1;

FIG. 3A is a plan view of the first substrate in FIG. 2;

FIG. 3B is a plan view of the second substrate in FIG. 2;

FIG. 4 is an exploded perspective view of the light source body in FIG. 1;

FIG. 5 is an exploded perspective view illustrating a light source body according to another embodiment of the present invention;

FIG. 6 is a schematic cross-sectional view illustrating a surface light source device according to another exemplary embodiment of the present invention;

FIG. 7 is a schematic cross-sectional view illustrating a surface light source device according to another exemplary embodiment of the present invention;

FIG. 8 is a schematic cross-sectional view illustrating a surface light source device according to another exemplary embodiment of the present invention;

FIG. 9 is a schematic cross-sectional view illustrating a surface light source device according to another exemplary embodiment of the present invention;

FIG. 10 is a schematic cross-sectional view illustrating a surface light source device according to another exemplary embodiment of the present invention;

FIG. 11 is a schematic cross-sectional view illustrating a surface light source device according to another exemplary embodiment of the present invention;

FIG. 12 is a schematic cross-sectional view illustrating a surface light source device according to another exemplary embodiment of the present invention;

FIG. 13A is a schematic cross-sectional view illustrating a surface light source device according to another embodiment of the present invention;

FIG. 13B is an enlarged view of portion ‘A’ in FIG. 13A;

FIG. 14A is a schematic cross-sectional view illustrating a surface light source device according to another embodiment of the present invention;

FIG. 14B is a schematic cross-sectional view illustrating a surface light source device according to another embodiment of the present invention; and

FIG. 15 is an exploded perspective view illustrating an image display apparatus of the present invention.

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention.

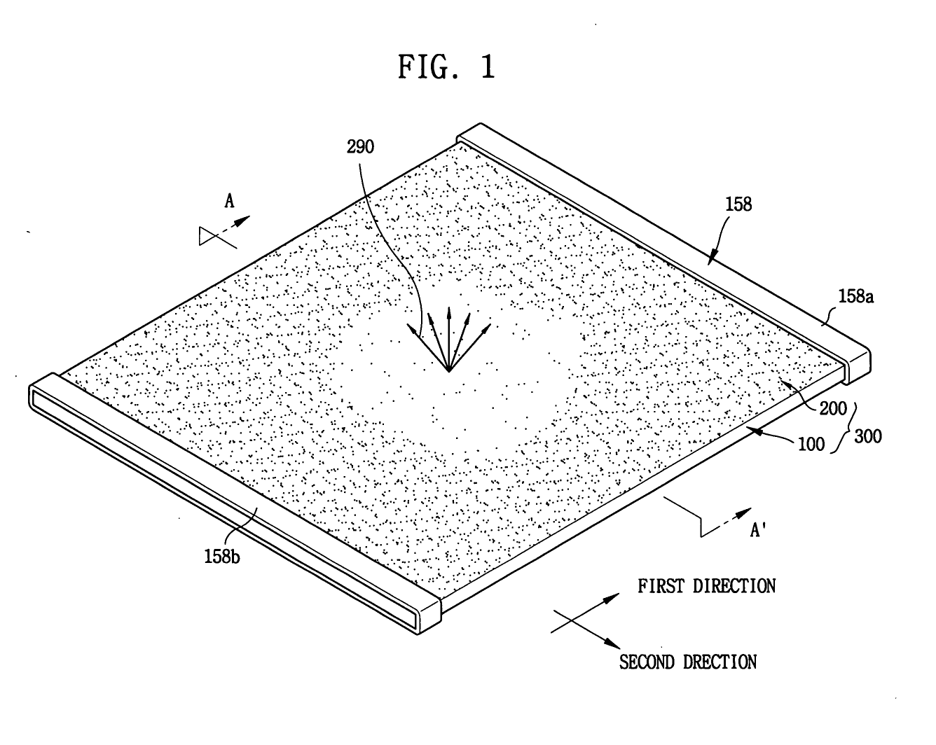

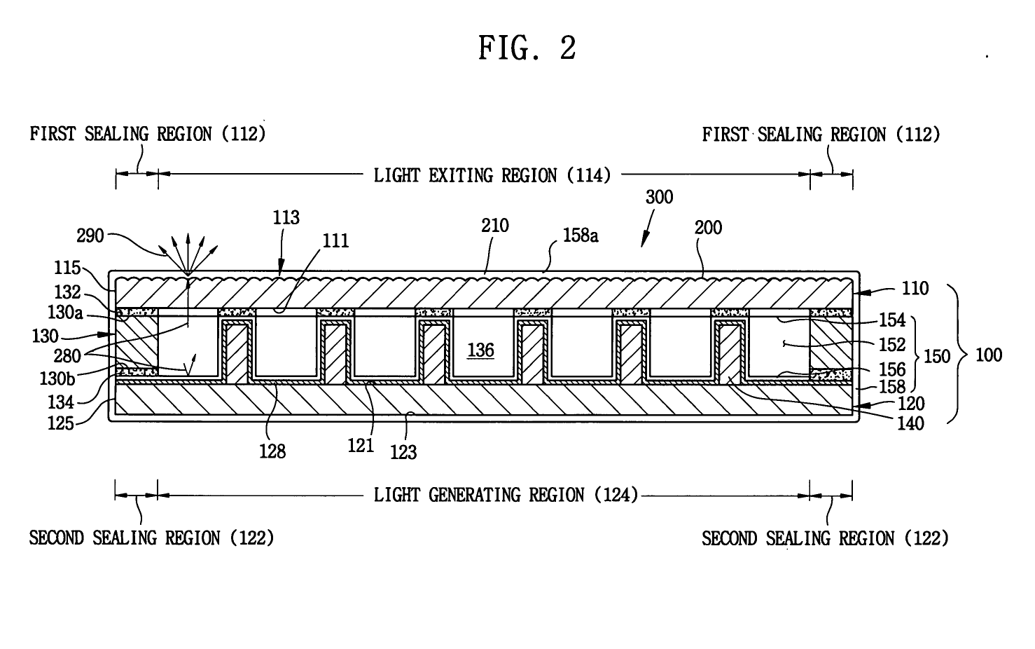

FIG. 1 is a perspective view showing a surface light source device according to an exemplary embodiment of the present invention, and FIG. 2 is a cross-sectional view of the surface light source device taken along line A-A′ in FIG. 1. Referring to FIGS. 1 and 2, the surface light source device includes a light source body 100 and a light diffusion part 200. The light source body 100 has an inner space 136 filled with a discharge gas 152 from which light is generated.

The light diffusion part 200 is formed on the surface of the surface light source device 300, though which the light 280 exits. The light diffusion part 200 transforms the light 280 into diffused light 290. The diffused light 290 has higher and more uniform luminance than that of the light 280 generated from the discharge gas 152 in the space 136 of the light source body 100. The light source body 100 includes first and second substrates 110 and 120, a sealing member 130, a partition 140 and a light generating part 150.

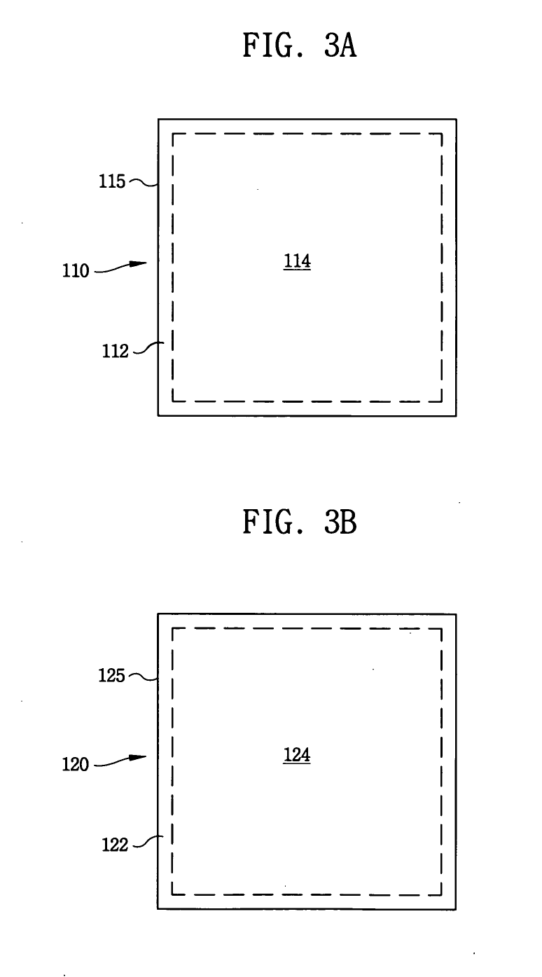

FIG. 3A is a plan view of the first substrate 110 in FIG. 2. Referring to FIGS. 2 and 3A, the first substrate 110 is transparent. For example, a glass substrate may be used as the first substrate 110. The first substrate 110 has a plate shape. The first substrate 110 includes a first sealing region 112 and a light exiting region 114. The first sealing region 112 surrounds the light exiting region 114.

The first substrate 110 includes a first surface 111 and a second surface 113. The first and second surfaces 111 and 113 are formed facing each other. The first substrate 110 has side surfaces 115 connecting the first and second surfaces 111 and 113. The number of the side surfaces 115 is three or more and determines the shape of the first substrate 110. In this embodiment, for example, the number of the side surfaces 115 is four. Thus, the first substrate 110 and the first and second surfaces 111 and 113 have a rectangular shape.

FIG. 3B is a plan view of the second substrate 120 in FIG. 2. Referring to FIGS. 2 and 3B, the second substrate 120 is transparent. For example, a glass substrate may be used as the second substrate 120. The second substrate 120 has a plate shape. The second substrate 120 includes a second sealing region 122 and a light generating region 124. The second sealing region 122 surrounds the light generating region 124.

The second substrate 120 includes a third surface 121 and a fourth surface 123. The third and fourth surfaces 121 and 123 are formed facing each other. The second substrate 120 also has side surfaces 125 connecting the third and fourth surfaces 121 and 123. The number of the side surfaces 125 is three or more and determines the shape of the second substrate 120. In this embodiment, for example, the number of the side surfaces 125 is four. Thus, the second substrate 120 and the third and fourth surfaces 121 and 123 have a rectangular shape.

Referring again to FIG. 2, the sealing member 130 is disposed at the first sealing region 112 of the first substrate 110 and the second sealing region 122 of the second substrate 120, so that a space is formed between the light exiting region 114 of the first substrate 110 and the light generating region 124 of the second substrate 120. The sealing member 130 is formed along an edge of the first and second substrates 110 and 120. The sealing member 130 comprises the same material as that of the first and second substrates 110 and 120. Thus, for example, the sealing member 130 comprises glass.

The sealing member 130 includes first and second sealing layers 132 and 134. The first sealing layer 132 is formed at a first surface 130a of the sealing member 130, which faces the first sealing region 112 of the first substrate 110. The second sealing layer 134 is formed at a second surface 130b of the sealing member 130, which faces the second sealing region 122 of the second substrate 120.

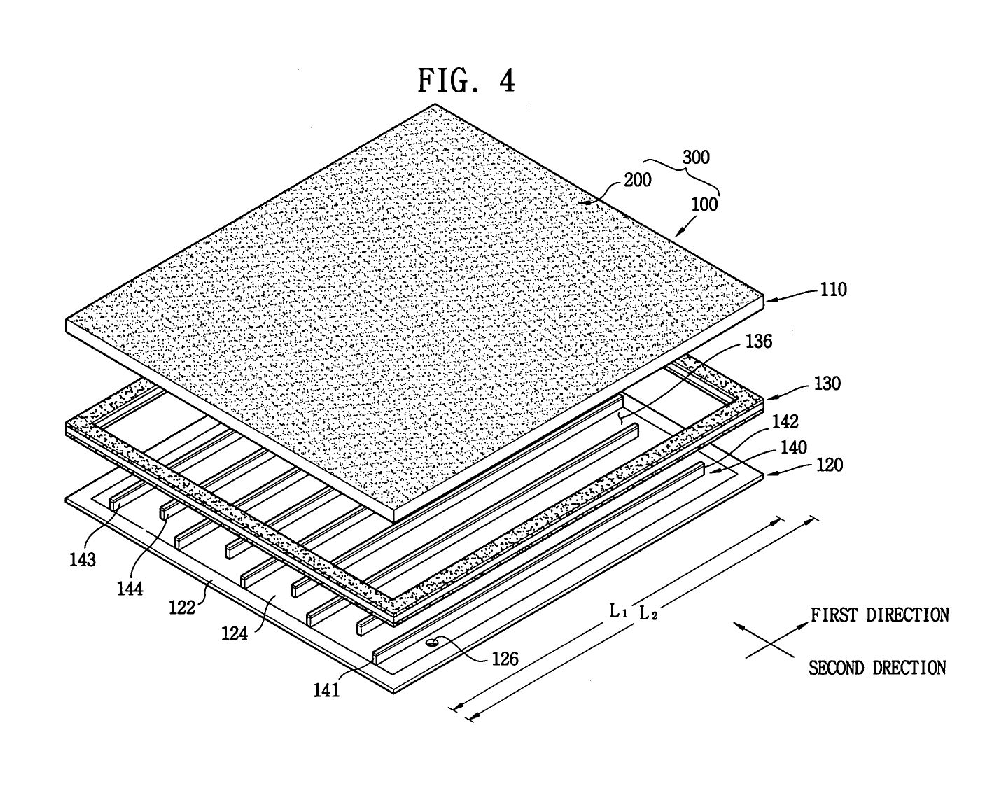

FIG. 4 is an exploded perspective view of the surface light source device 300. Referring to FIGS. 2 and 4, the partitions 140 divide the space formed between the light exiting region 114 of the first substrate 110 and the light generating region 120 of the second substrate 120 to form a light generating space 136. The partitions 140 each have a bar shape and have first and second end portions 141 and 142 that are respectively disposed at the ends of each partition.

In FIG. 4, the first direction is the longitudinal direction of the partitions 140, and the second direction is substantially perpendicular to the first direction. The partitions 140 are arranged in the second direction and parallel with each other. The partitions 140 have a substantially identical longitudinal length L1 that is shorter than a first directional length L2 of the light generating region 124.

One of the first and second end portions 141 and 142 of the respective partitions 140 is in contact with the sealing member 130. For example, the odd numbered partitions 143 of the partitions 140 are in contact with the sealing member 130 at their first end portions 143, respectively, and the even numbered partitions 144 are in contact with the sealing member 130 at their second end portions 142, respectively. Thus, the partitions 140 are disposed in zigzag shape, so that the light generating space 136 divided by the partitions 140 is connected to form a serpentine shape. Therefore, a pressure of the discharge gas injected via an injection hole 126 and disposed in each of the light generating spaces 136 is substantially identical in the light generating space 136.

Referring to FIGS. 2 and 4, the light generating part 150 is divided by the partitions 140 to form the light generating spaces 136. The light is generated from the discharge gas 152 in the light generating space 136. The light generating part 150 includes first and second fluorescent layers 154 and 156, the discharge gas 152 and a voltage applying part 158.

The first fluorescent layer 154 is formed on the first surface 111 of the first substrate 110. The first fluorescent layer 154 is formed either on the entire area or partial areas of the first surface 111. In other words, the first fluorescent layer 154 is formed on the entire first surface 111 of the first substrate 110 or on selected areas of the first surface 111 of the first substrate 110.

In this embodiment, the first fluorescent layer 154 is formed on selected partial areas of the first surface 111 of the first substrate 110. In particular, the first fluorescent layer 154 is not formed on the areas of the first surface 111 on which the partitions 140 are attached. The first fluorescent layer 154 that partially covers the first surface 111 may be formed using a printing method. The first fluorescent layer 154 transforms an invisible light, such as ultraviolet light, into visible light 280 (hereinafter, referred to as light).

The second fluorescent layer 156 is formed on the surface of the partition 140. The second fluorescent layer 156 is also formed on the third surface 121 of the second substrate 120. The second fluorescent layer 156 that covers the surface of the partition 140 and the third surface 121 of the second substrate 120 may be formed using a spray method. The second fluorescent layer 156 also transforms the invisible light into the visible light 280.

The discharge gas 152 is injected into the light generating space 136 defined by the first and second substrates 110 and 120 and the partitions 140. The discharge gas 152 emits the invisible light when the discharge gas 152 is electrically discharged. The discharge gas includes mercury (Hg). The discharge gas may further include argon (Ar), xenon (Xe), krypton (Kr), or a mixture thereof.

Referring again to FIGS. 1 and 2, the voltage applying part 158 provides a discharge voltage to electrically discharge the discharge gas 152 in the light generating space 136, so that the invisible light is generated. The voltage applying part 158 includes first and second electrodes 158a and 158b. Both the first and second electrodes 158a and 158b may be disposed inside the light source body 100. One of the first and second electrodes 158a and 158b may be disposed outside the light source body 100, or both the first and second electrodes 158a and 158b may be disposed outside the light source body 100. In this embodiment, both the first and second electrodes 158a and 158b are disposed outside the light source body 100.

The voltage applying part 158 applies the discharge voltage in the range from a few kV to a few tens kV to the light generating space 136. Thus, the discharge gas of the light generating space 136 becomes in an exited state and returns to a stable state to generate the invisible light.

The light 280 exits from the light source body 100 via both the first and second substrates 110 and 120 of the light source body 100 because the first and second fluorescent layers 154 and 156 are formed on the first and second substrates 110 and 120, respectively, which are transparent. Since the light source body 100 emits light through both the substrates 110 and 120, it may be used for an display device having different display regions in different directions. For example, a mobile phone has main and sub display panels disposed in two different directions. The light source body 100 may be used in the mobile phone to provide light to the main and sub display panels in different directions.

In the embodiment of FIG. 2, a light reflecting layer 128 is added to reflect light toward the first substrate 110 of the light source body 100. The light reflecting layer 128 is interposed between the second fluorescent layer 156 and the third surface 121 of the second substrate 120, so that the light 280 exits from only the first substrate 110 of the light source body 100. As a result, the luminance of the light 280 exiting the first substrate 110 is enhanced. The light reflecting layer 128 reflects the light 280 that travels to the third surface 121 of the second substrate 120 toward the first surface 111 of the first substrate 110. The light reflecting layer 128 comprises aluminum oxide (Al₂O₃) or titanium oxide (TiO₃).

The light diffusion part 200 of the surface light source device 300 diffuses the light 280 to transform the light 280 into the diffused light 290 that has a uniform luminance. The light diffusion part 200 includes a light diffusion pattern 210 formed on the second surface 113 of the first substrate 110. The second surface 113 of the first substrate 110 is embossed to form the light diffusion pattern 210. In other words, the light diffusion pattern 210 has a number of convex surfaces successively formed on the second surface 113 of the first substrate 110. The light diffusion pattern 210 diffuses the light 280 to increase uniformity of the luminance.

To form the light diffusion part 200 on the second surface 113 of the first substrate, a sand blaster method may be used such that the second surface 113 is subjected to impact of sand particles, or a grinding method may be used such that the second surface 113 is grinded to form the light diffusion pattern 210. Chemical, such as hydrogen fluoride (HF), may be used to form the light diffusion pattern 210.

According to the present embodiment, the light source body 100 generates the light 280 having two-dimensions, and the light diffusion pattern 210 diffuses the light 280 to increase the uniformity of the luminance. Thus, a display device (e.g., liquid crystal display) improves its display quality by employing the surface light source device having above described structure.

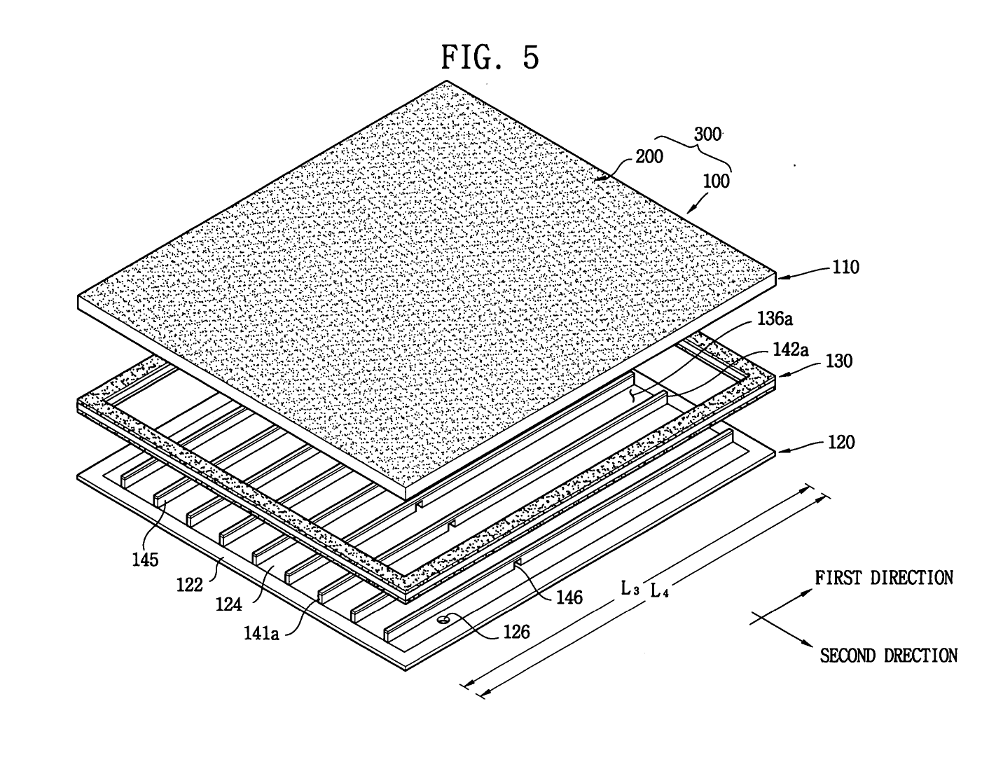

FIG. 5 is an exploded perspective view illustrating a light source body according to anther embodiment of the present invention. In FIG. 5, the same parts as those shown in FIG. 4 are represented with like reference numerals and a detailed description thereof will be omitted to avoid description duplication.

In this embodiment, the partitions 145 have a substantially identical length L3 that is substantially same as a first directional length L4 of the light generating region 124. Thus, first and second end portions 141a and 141b of the respective partitions 145 are in contact with the sealing member 130.

When the first and second end portions 141a and 142a make contact with the sealing member 130, the light generating space is completely divided. In this case, the discharge gas needs to be separately injected in each light generating space, and each light generating space may have different pressure of the discharge gas.

In the embodiment of FIG. 5, such problem is solved by forming a through-hole 146 in the respective partitions 145. The light generating spaces 136a are connected to each other via the though holes 146. Thus, the discharge gas is injected into the light generating spaces 136a via the injection hole 126.

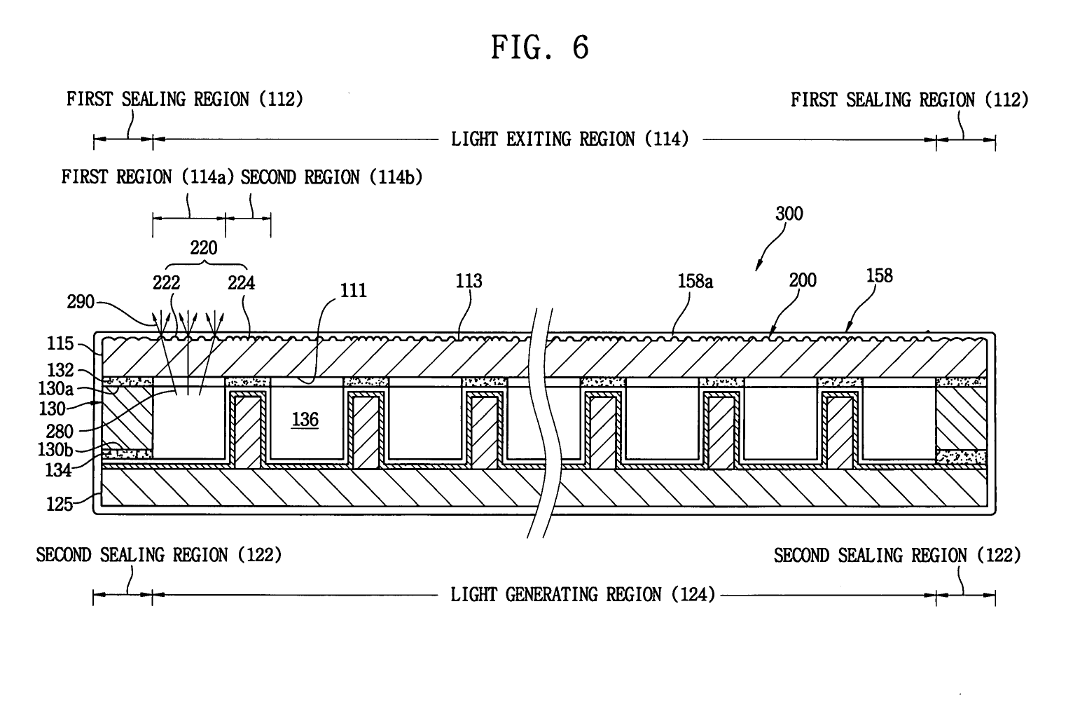

FIG. 6 is a schematic cross-sectional view illustrating a surface light source device according to another exemplary embodiment of the present invention. The surface light source device 300 of the present embodiment is substantially same as the one in FIG. 2, except for the light diffusion part. Thus, in FIG. 6, the same parts as those shown in FIG. 2 are represented with like reference numerals and a detailed description thereof will be omitted to avoid description duplication.

Referring to FIG. 6, a light diffusion part 220 formed on the second surface 113 of the first substrate 110 includes first and second light diffusion patterns 222 and 224. The first and second light diffusion patterns 222 and 224 are formed on first and second regions 114a and 114b of the light exiting region 114 respectively. The first region 114a is disposed above the light generating space 136, and the second region 114b is disposed above the partition 140.

The first light diffusion pattern 222 of the first region 114a has first convex members each having a predetermined size, and a predetermined number (M) of the first convex members are formed at a unit area. The second light diffusion pattern 224 of the second region 114b has second convex members each having a predetermined size, and a predetermined number (N) of the second convex members are formed at a unit area. In this embodiment, the sizes of the first and second convex members are substantially identical, and the number (M) of the first convex members is smaller than the number (N) of the second convex members. In other words, the second region 114b has a higher density of the convex members than in the first region 114a. As a result, the luminance at the second region 114b increases up to a level substantially equal to the luminance at the first region 114a.

According to the present embodiment, the light diffusion pattern 220 is formed on the light source body 100, such that the first and second light diffusion patterns 222 and 224 each have a different density of the convex members at which the light is diffused. The first light diffusion pattern 222 formed above the light generating space 136 has relatively sparse convex members, and the second light diffusion pattern 224 formed above the partition 140 has relatively dense convex members. As a result, the luminance of the diffused light 290 becomes uniform at the first and second regions 114a and 114b of the light exiting region 114.

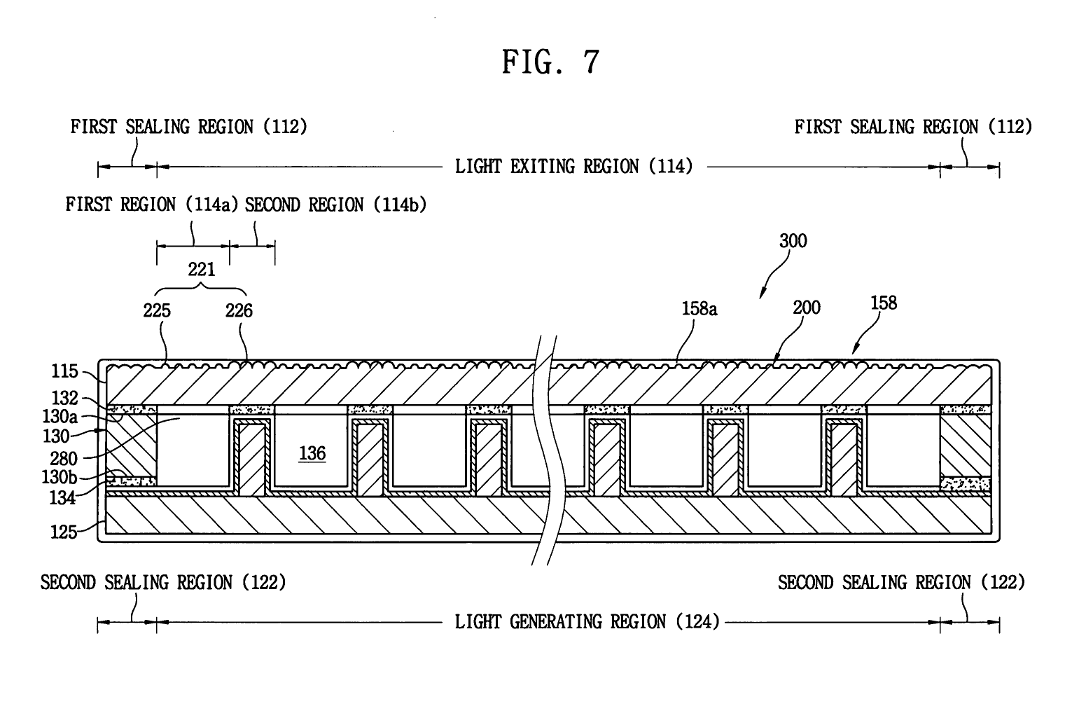

FIG. 7 is a schematic cross-sectional view illustrating a surface light source device according to another exemplary embodiment of the present invention. The surface light source device 300 of the present embodiment is substantially same as the one in FIG. 2, except for the light diffusion part. Thus, in FIG. 7, the same parts as those shown in FIG. 2 are represented with like reference numerals and a detailed description thereof will be omitted to avoid description duplication.

Referring to FIG. 7, the light diffusion part 200 formed on the second surface 113 of the first substrate 110 has a light diffusion pattern 211 including first and second light diffusion patterns 225 and 226. The first and second light diffusion patterns 225 and 226 are formed at the first and second regions 114a and 114b, respectively, of the light exiting region 114. The first region 114a is disposed above the light generating space 136, and the second region 114b is disposed above the partition 140.

The first light diffusion pattern 225 has convex members of a first size, and a number (M) of the convex members are formed at a unit area of the first region 114a. The second light diffusion pattern 226 has convex members of a second size that is larger than the first size, and a number (N) of the convex members are formed at a unit area of the second region 114b. In this embodiment, the numbers (M and N) of the convex members of the first and second light diffusion patterns 225 and 226 are substantially same. Thus, the luminance at the second region 114b increases up to a level substantially equal to the luminance of the first region 114a.

According to the present embodiment, the light diffusion part 221 is formed on the light source body 100, such that the convex members of the first light diffusion pattern 225 have a different size than those of the second light diffusion pattern 226. In other words, the convex members of the first light diffusion pattern 225 formed above the light generating space 136 have a relatively small size, and the convex members of the second light diffusion pattern 226 formed above the partition 140 has a relatively large size. Thus, the luminance of the diffused light 290 becomes uniform at the first and second regions 114a and 114b.

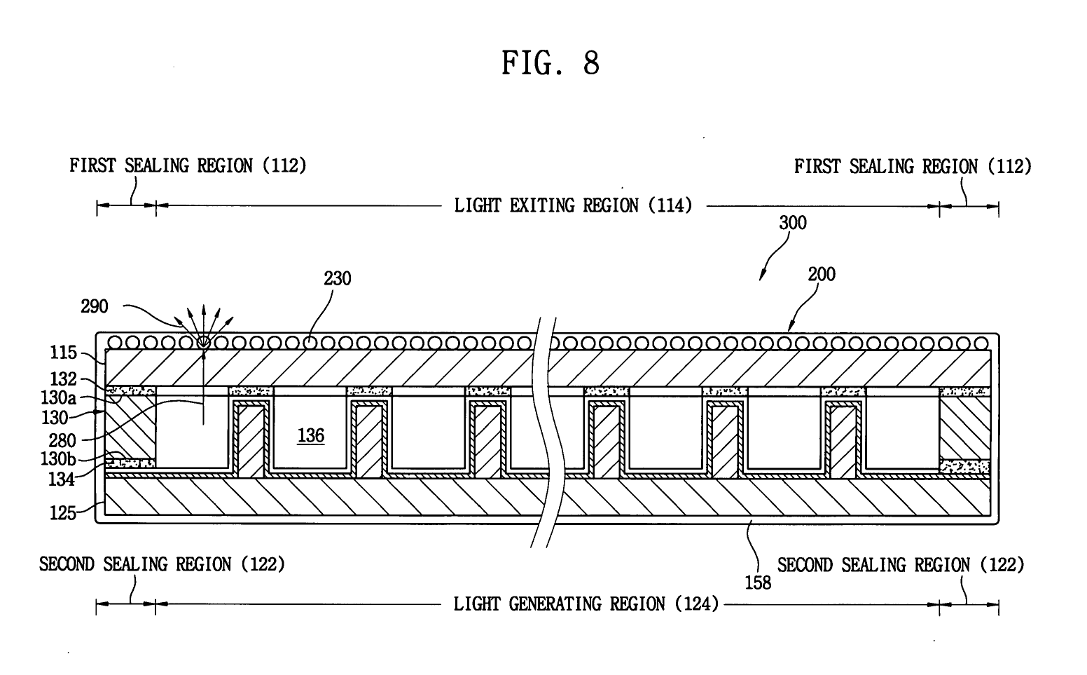

FIG. 8 is a schematic cross-sectional view illustrating a surface light source device according to another exemplary embodiment of the present invention. The surface light source device 300 of the present embodiment is substantially same as the one in FIG. 2, except for the light diffusion part. Thus, in FIG. 8, the same parts as those shown in FIG. 2 are represented with like reference numerals and a detailed description thereof will be omitted to avoid description duplication.

Referring to FIG. 8, the light diffusion part 200 is formed on the second surface 113 of the first substrate 110. The light diffusion part 200 includes light diffusion members 230. Each of the light diffusion members 230 has a spherical particle shape. The light diffusion members 230 has a refractivity that is, for example, different from that of the first substrate 110. The refractivity of the light diffusion members 230 may be also different from the refractivity of air. The light diffusion members 230 have a substantially identical size. The light diffusion members 230 are attached on the second surface 113 of the first substrate 110 by adhesive.

The light 280 generated from the discharge gas in the light generating space 136 passes through the first surface 111 of the first substrate 110, and arrives at the light diffusion members 230. Then, the light 280 is reflected or refracted by the light diffusion members 230, so that the light 280 is transformed into the diffused light 290 that has a uniform luminance.

According to the present embodiment, the light diffusion part 200 includes the light diffusion members 230 for diffusing the light 280 generated from the discharge gas of the light generating space 136 to uniformize the luminance of the light.

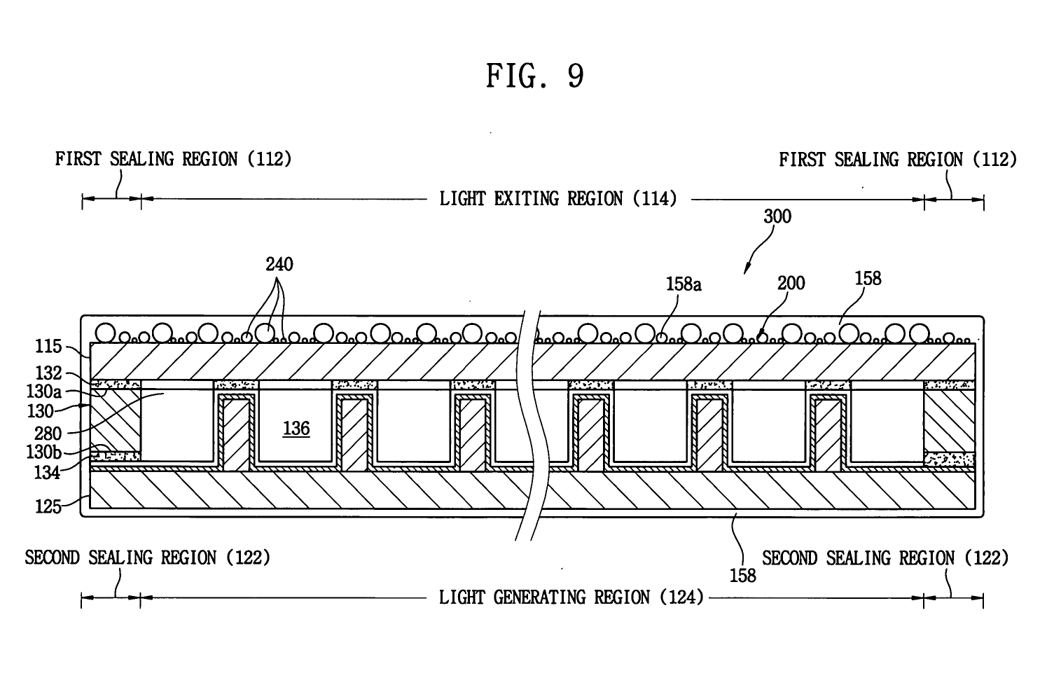

FIG. 9 is a schematic cross-sectional view illustrating a surface light source device according to another exemplary embodiment of the present invention. The surface light source device of the present embodiment is substantially same as the one in FIG. 2, except for the light diffusion part. Thus, in FIG. 9, the same parts as those shown in FIG. 2 are represented with like reference numerals and a detailed description thereof will be omitted to avoid description duplication.

Referring to FIG. 9, the light diffusion part 200 is formed on a second surface 113 of the first substrate 110. The light diffusion part includes light diffusion members 240. The light diffusion members 240 have a spherical particle shape. The light diffusion members 240 have a refractivity that is, for example, different from that of the first substrate 110. The refractivity of the light diffusion members 240 may be also different from the refractivity of air. In this embodiment, the light diffusion members 240 each have a different size. The light diffusion members 240 with various sizes are attached on the second surface 113 of the first substrate 110 by adhesive.

The light 280 generated from the discharge gas in the light generating space 136 passes through the first surface 111 of the first substrate 110, and arrives at the light diffusion members 240. Then, the light 280 is reflected or refracted by the light diffusion members 240, so that the light 280 is transformed into the diffused light 290 that has a uniform luminance.

According to the present embodiment, the light diffusion part 200 includes the light diffusion members 240 with various sizes for diffusing the light 280 generated from the discharge gas of the light generating space 136 to uniformize the luminance of the light.

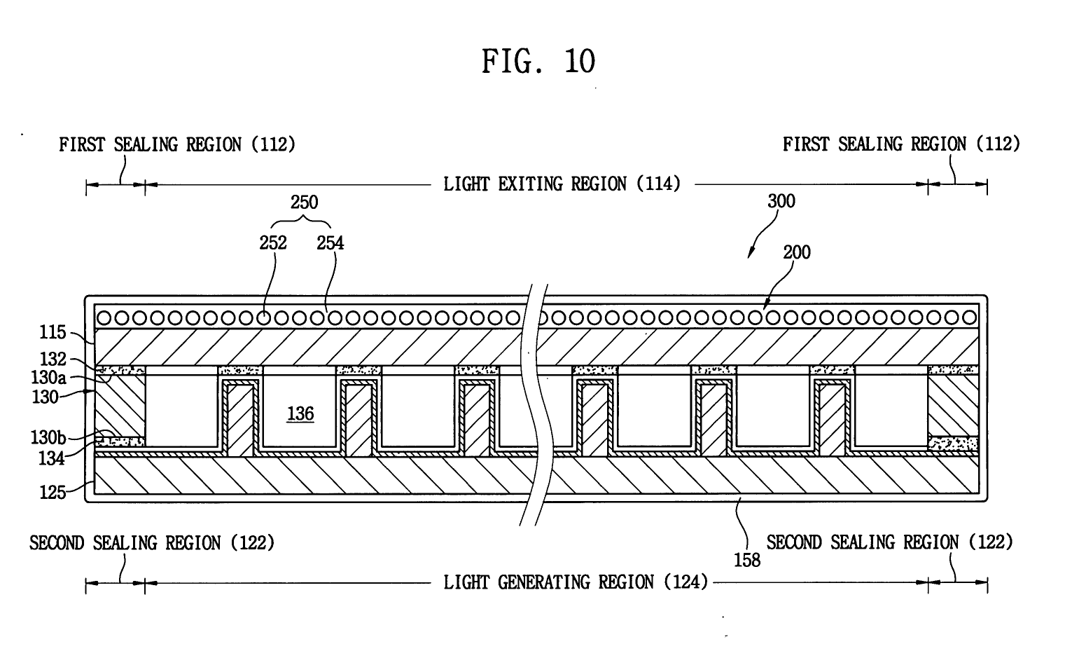

FIG. 10 is a schematic cross-sectional view illustrating a surface light source device according to another exemplary embodiment of the present invention. The surface light source device 300 of the present embodiment is substantially same as the one in FIG. 2, except for the light diffusion part. Thus, in FIG. 10, the same parts as those shown in FIG. 2 are represented with like reference numerals and a detailed description thereof will be omitted to avoid description duplication.

Referring to FIG. 10, the light diffusion part 200 is formed on the second surface 113 of the first substrate 110. The light diffusion part 200 includes a light diffusion member 250. The light diffusion member 250 includes beads 252 and a binder 254. The beads 252 have a spherical particle shape, and the binder 254 fixes the beads 252 in the light diffusion member 250.

The beads 252 are transparent and have a refractivity that is, for example, different from that of the first substrate 110. The beads 252 may have a substantially same size or different sizes. The binder 254 has fluidity and adhesiveness to securely hold the beads 252 on the second surface of the first substrate. The refractivity of the binder 254 is different from that of the beads 252. The binder 254 is disposed to coat the second surface 113 of the first substrate 110.

According to the present embodiment, the light diffusion part 200 includes the light diffusion member 250 having the beads 252 with a substantially same size and the binder 254 coated on the second surface 113 of the first substrate 110 to diffuse the light 280 generated from the discharge gas in the light generating space 136. As a result, the diffused light has a uniform luminance distribution.

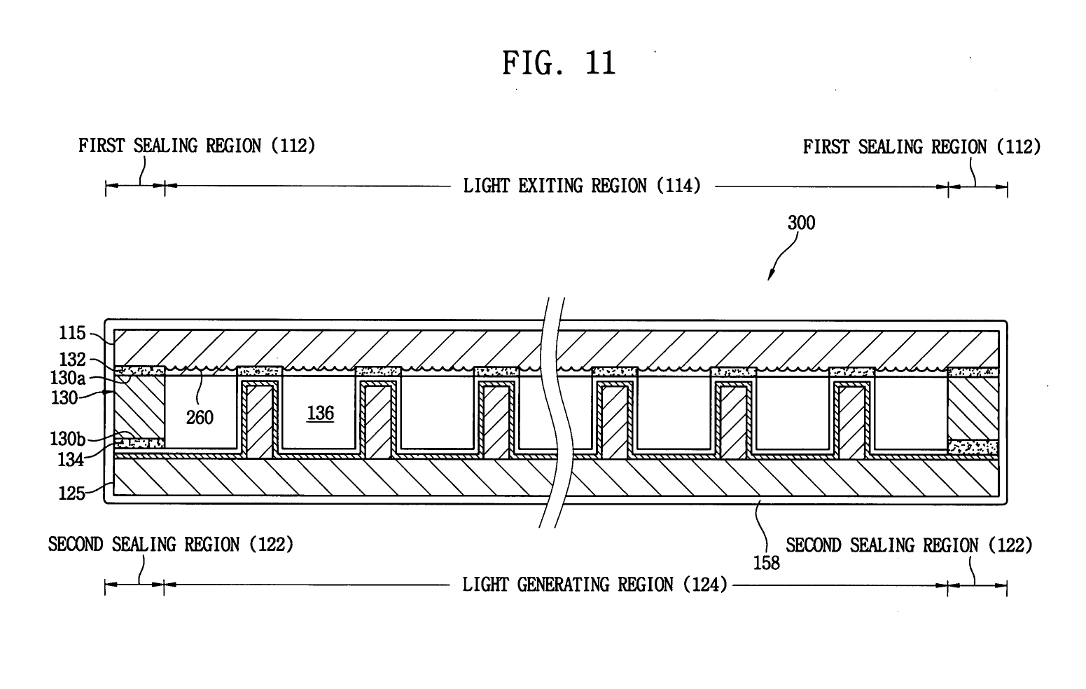

FIG. 11 is a schematic cross-sectional view illustrating a surface light source device according to another exemplary embodiment of the present invention. The surface light source device 300 of the present embodiment is substantially same as the one in FIG. 2, except for the light diffusion part. Thus, in FIG. 11, the same parts as those shown in FIG. 2 are represented with like reference numerals and a detailed description thereof will be omitted to avoid description duplication.

Referring to FIG. 11, the light diffusion part 200 has a light diffusion pattern 260 formed on the first surface 111 of the first substrate 110. The first surface 111 is embossed to form the light diffusion pattern 260. In other words, the light diffusion pattern 260 has a number of convex surfaces successively formed on the first surface 111 of the first substrate 110. In this embodiment, the light diffusion pattern 260 has no convex surface at the region of the first surface 111, where the first sealing layer 132 is attached. The light diffusion part with the light diffusion pattern 260 diffuses the light from the light generating space 136 so as to increase the luminance of the light output from the first substrate.

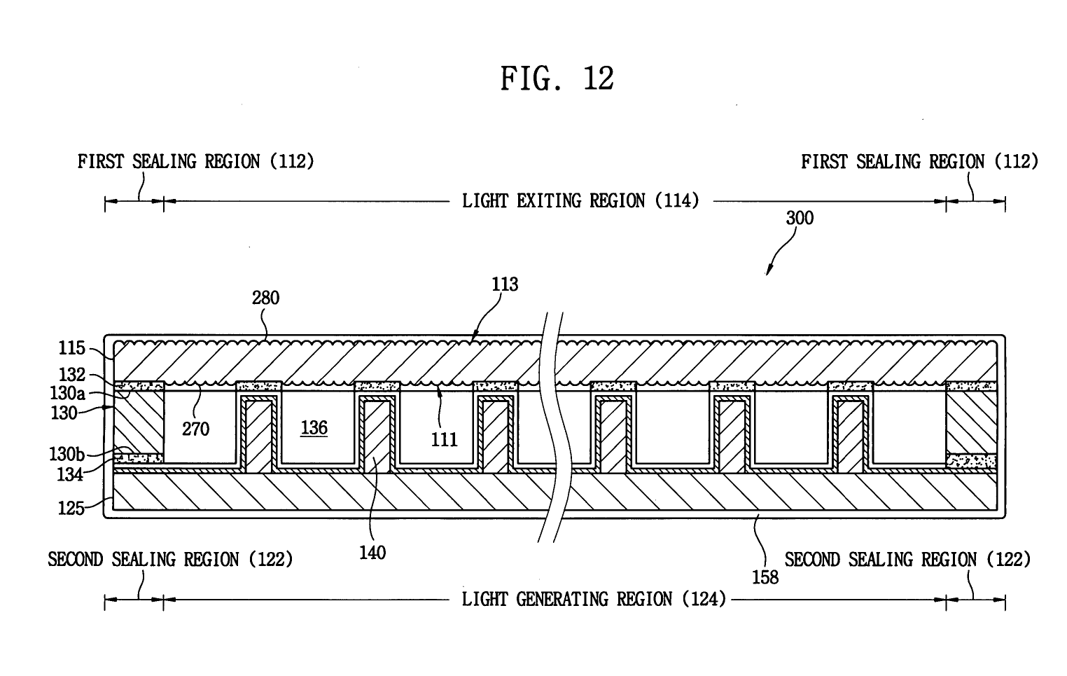

FIG. 12 is a schematic cross-sectional view illustrating a surface light source device according to anther embodiment of the present invention. The surface light source device 300 of the present embodiment is substantially same as the one in FIG. 2, except for the light diffusion part. Thus, in FIG. 12, the same parts as those shown in FIG. 2 are represented with like reference numerals and a detailed description thereof will be omitted to avoid description duplication.

Referring to FIG. 12, the light diffusion part has first and second light diffusion patterns 270 and 280 formed on the first and second surfaces 111 and 113, respectively, of the first substrate 110. The first surface 111 is embossed to form the first diffusion pattern 270 such that a number of convex surfaces are successively formed on the first surface 111 of the first substrate 110. The second surface 113 is embossed to form the second diffusion pattern 280 such that a number of convex surfaces are successively formed on the second surface 113 of the first substrate 110.

In this embodiment, the light generated from the discharge gas of the light generating space 136 is diffused by the first light diffusion pattern 270, and then diffused again by the second light diffusion pattern 280. As a result, the light output from the first substrate 110 has a uniform luminance.

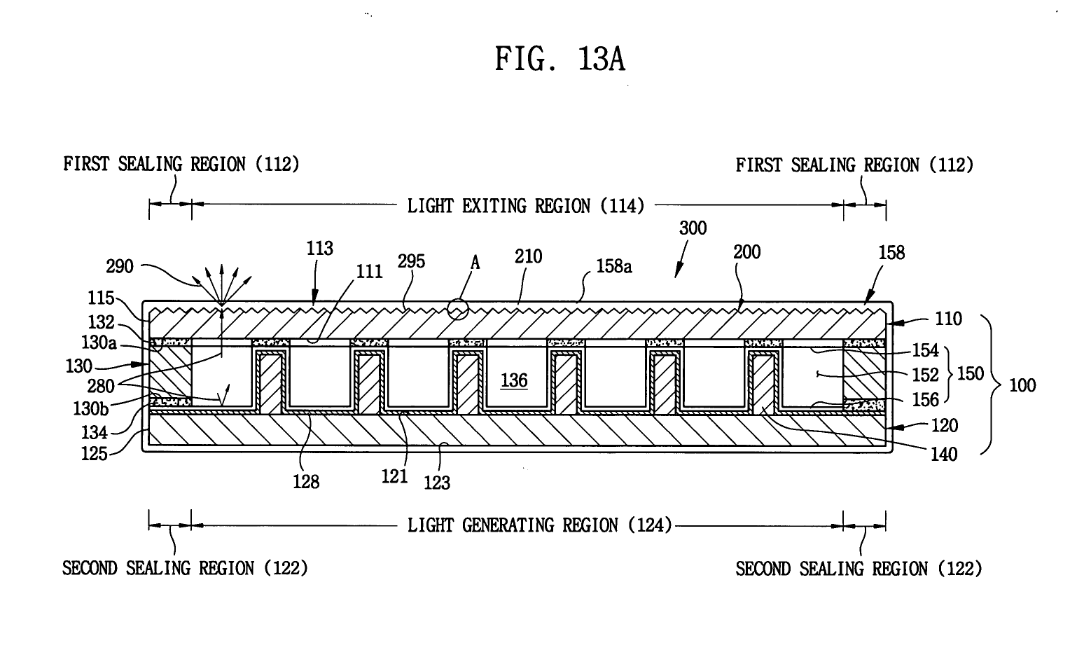

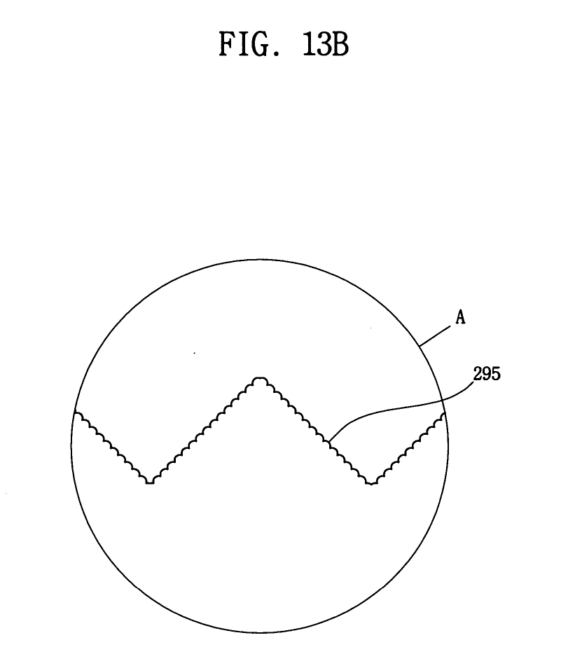

FIG. 13A is a schematic cross-sectional view illustrating a surface light source device according to another embodiment of the present invention, and FIG. 13B is an enlarged view of portion ‘A’ in FIG. 13A. The surface light source device in FIG. 13A is substantially same as the one in FIG. 2, except for the light diffusion part. Thus, in FIG. 13A, the same parts as those shown in FIG. 2 are represented with like reference numerals and a detailed description thereof will be omitted to avoid description duplication.

Referring to FIGS. 13A and 13B, the light diffusion part 200 diffuses the light 280 generated from the discharge gas of the light generating space 136 to transform the light 280 into the diffused light 290. The light diffusion part 200 has a light diffusion pattern 295 formed on the second surface 113 of the first substrate 110. The light diffusion pattern 295 has a number of V-shaped grooves formed on the second surface 113 of the first substrate 110.

The V-shaped grooves are spaced apart each other by about 50 μm. The surface of the light diffusion pattern 295 is rough. For example, the surfaces of the V-shaped grooves are embossed as shown in FIG. 13B. Thus, the traveling direction of the light 130 generated from the discharge gas in the light generating space 136 is adjusted by the V-shaped grooves, and the light 130 is diffused by the rough surfaces of the V-shaped grooves to transform the light 130 into the diffused light 290. As a result, uniformity of the luminance increases. The V-shaped grooves may be formed, for example, by compressing the second surface 113 of the first substrate 110, when being heated, with a stamp having a negative or positive pattern.

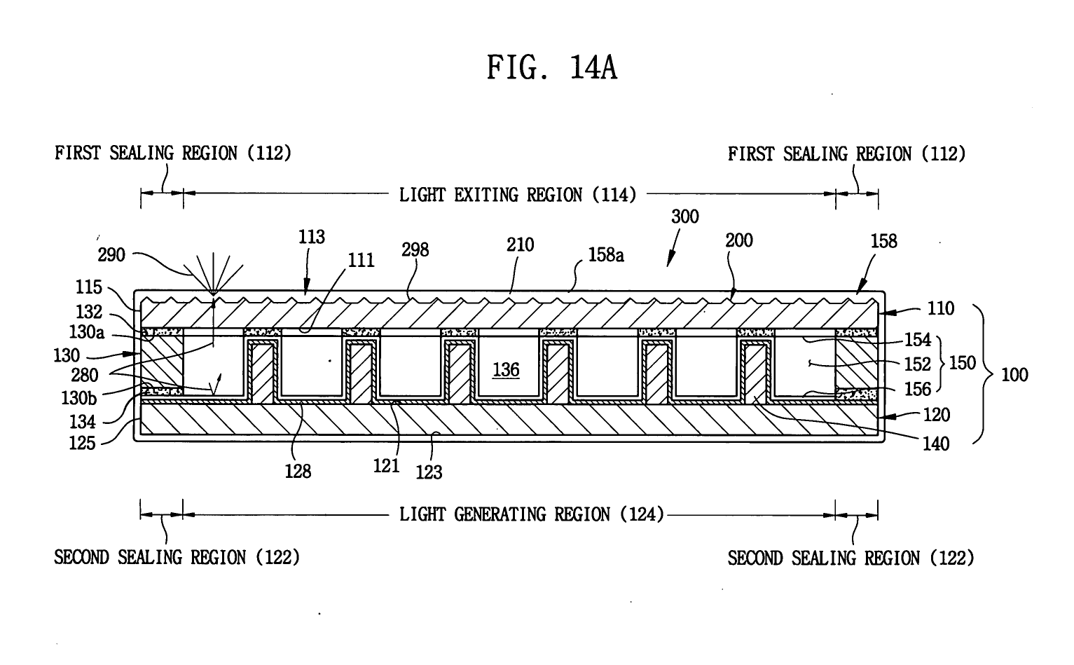

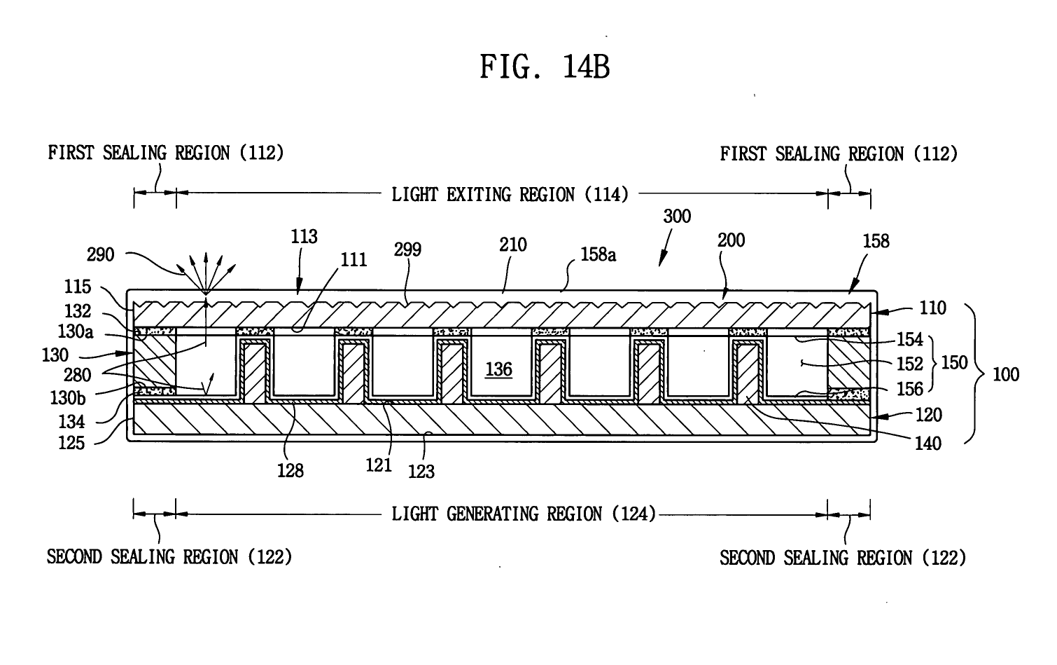

FIG. 14A is a schematic cross-sectional view illustrating a surface light source device according to another embodiment of the present invention, and FIG. 14B is a schematic cross-sectional view of a surface light source device modified from the embodiment in FIG. 14A. The embodiments of the surface light source device are substantially same as the one in FIG. 2, except for the light diffusion part. Thus, in FIGS. 14A and 14B, the same parts as those shown in FIG. 2 are represented with like reference numerals and a detailed description thereof will be omitted to avoid description duplication.

Referring to FIG. 14A, the light diffusion part 200 diffuses the light 280 generated from the discharge gas in the light generating space 136 so as to transform the light 280 into the diffused light 290. Thus, uniformity of the luminance increases. The light diffusion part 200 includes a light diffusion pattern 298 formed on the second surface 113 of the first substrate 100. The light diffusion pattern 298 has a number of protrusion members each having, for example, a prism shape. The protrusion members are discretely formed on the second surface 113 such that the adjacent protrusion members are apart each other by a predetermined distance. The protrusion members each may have a prism shape with a cross-sectional view of a triangular shape, a rectangular shape, a pentagonal shape or other polygonal shape. The light diffusion pattern 298 may also have a rough surface to increase the diffusion effect with respect to the light 280. In this case, the traveling direction of the light 280 is adjusted by the protrusion members, and the light 280 is diffused by the rough surface of the light diffusion pattern 298. As a result, the diffused light 290 has a uniform luminance distribution.

Referring to FIG. 14B, the light diffusion part 200 includes a light diffusion pattern 299 having a number of grooves. The second surface 113 of the first substrate 110 is partially recessed to form the grooves that are discretely formed such that the adjacent grooves are apart each other by a predetermined distance. The grooves of the light diffusion pattern 299 each have a cross-sectional view of a polygonal shape, such as a triangular shape, a rectangular shape, a pentagonal shape, etc.

The grooves of the light diffusion pattern 299 may have a rough surface to increase the diffusion effect. The traveling direction of the light 280 is adjusted by the grooves, and the light 280 is diffused by the rough surface of the light diffusion pattern 299. As a result, the diffused light 290 has a uniform luminance distribution.

For example, the light diffusion patterns 298 and 299 in FIGS. 14A and 14B are formed using the following method. The light diffusion pattern 298 or 299 is exposed and developed on a photosensitive layer. Then, a metal layer is formed on the photosensitive layer by sputtering method. A light diffusion pattern shape is transcribed on a thin metal plate via the metal layer having the light diffusion pattern shape. Then, the metal plate having the light diffusion pattern shape is attached on a roller, so that a transcription roller is formed. The second surface 113 of the first substrate 110 is heated. The transcription roller rolls on the second surface 113. As a result, the light diffusion pattern is formed.

In the above description, the light diffusion pattern of the surface light source device of the present invention is explained with reference to the exemplary embodiments. It should be noted that the shape of the light diffusion pattern is not limited to the shapes described in the above embodiments and shown in the drawings. The light diffusion pattern may have various shapes and be readily modified within the scope of the present invention by one skilled in the art. For example, the light diffusion part may have an irregular pattern as well as a regular pattern.

In the surface light source device of the present invention, since the light diffusion part is formed inside the light source body, the light is not totally reflected but exits from the light source body. Thus, the luminance of the surface light source device increases. For example, the surface light source device with the light diffusion part according to the present invention has the luminance of 3760 cd, while a conventional surface light source device has the luminance of 3300 cd.

The surface light source device of the present invention may be employed in a display apparatus displaying images using the light separately provided. As an example, described below is a liquid crystal display apparatus including the surface light source device of the present invention.

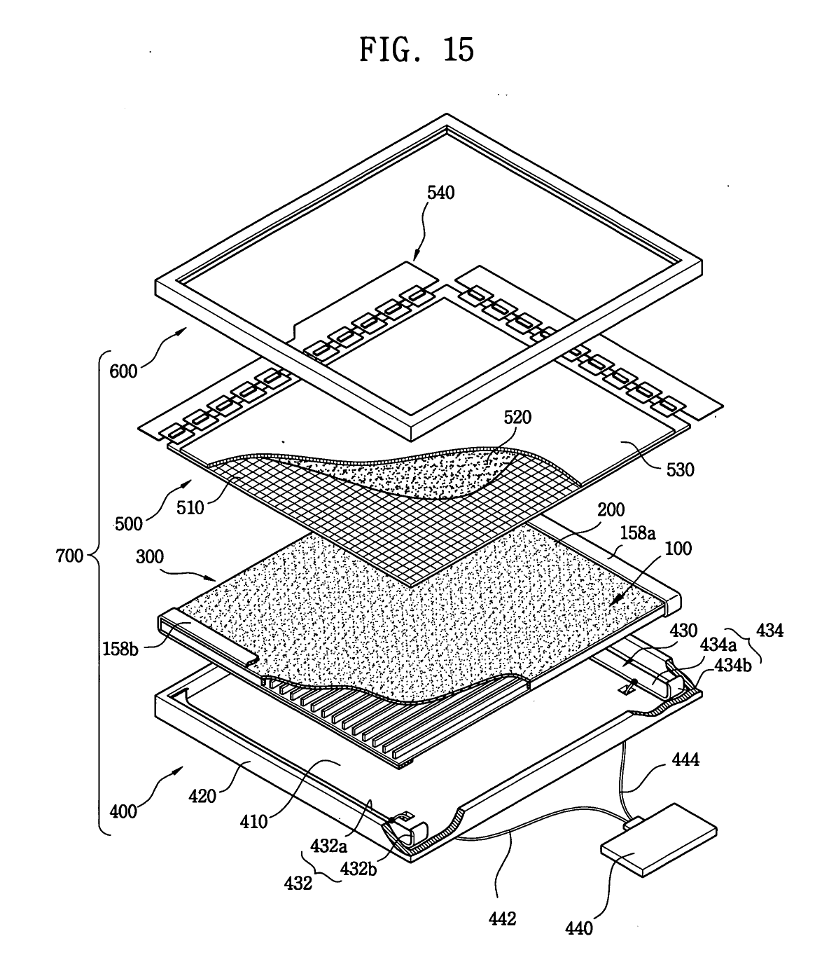

FIG. 15 is an exploded perspective view illustrating a liquid crystal display apparatus of the present invention. The liquid crystal display apparatus 700 includes a receiving container 400, a surface light source device 300, a liquid crystal display panel 500 and chassis 600. The surface light source device 300 may be one of the embodiments described above. Thus, a detailed description of the light source device will be omitted.

The receiving container 400 includes a bottom plate 410 and sidewalls 420. The sidewalls 420 are disposed at edge portions of the bottom plate 410. The bottom plate 410 and the sidewalls 420 form a receiving space. The receiving container 400 receives the surface light source device 300 and the liquid crystal display panel 500 such that the surface light source device 300 and the liquid crystal display panel 500 are securely held therein.

The surface light source device 300 includes a light source body 100 and a light diffusion part 200. The light source body 100 includes a space having a flat shape, and light is emitted from the space. The light diffusion part 200 is formed on a selected region of the light source body 100, and the light exits the light source body 100 through the light diffusion part 200. The light diffusion part 200 diffuses the light generated from discharge gas in the space of the light source body 100 so that the diffused light has a uniform luminance distribution.

The liquid crystal display panel 500 transforms the light generated from the surface light source device into image light that contains image information. The liquid crystal display panel 500 includes a thin film transistor substrate 510, a liquid crystal layer 520, a color filter substrate 530 and a driver module 540.

The thin film transistor substrate 510 includes pixel electrodes, thin film transistors, gate lines and data lines. The pixel electrodes are arranged in a matrix form. Thin film transistors are electrically connected to the pixel electrodes respectively. In detail, a drain electrode of the thin film transistor is electrically connected to the pixel electrode. A gate electrode of the thin film transistor is electrically connected to the gate line. A source electrode of the thin film transparent is electrically connected to the source line.

The color filter substrate 530 includes color filters and a common electrode. The color filters are disposed such that the color filter faces the pixel electrodes respectively. The common electrode is formed on the color filters. The liquid crystal layer 520 is interposed between the thin film transistor substrate 510 and the color filter substrate 530.

The chassis 600 enwraps the edge portions of the liquid crystal display panel 500. The chassis 600 is combined with the receiving container 400. The chassis 600 protects the liquid crystal display panel 500 to prevent the liquid crystal display panel from being broken and separating from the receiving container 400.

The surface light source device generates the light having uniform luminance in comparison with conventional light source devices, such as a light emitting diode or a cold cathode fluorescent lamp.

Having described the exemplary embodiments of the surface light source device and the display device employing the same according to the present invention, modifications and variations can be readily made by those skilled in the art in light of the above teachings. It is therefore to be understood that, within the scope of the appended claims, the present invention can be practiced in a manner other than as specifically described herein.

1. A surface light source device comprising:
a light source body to generate light in response to an electric signal, the light source body having a space filled with a discharge gas to generate the light; and
a light diffusion part to diffuse the light generated from the light source body to output diffused light.

2. The surface light source device of claim 1, wherein the light diffusion part is integrally formed with the light source body.

3. The surface light source device of claim 2, wherein the light source body comprises:
a first substrate through which the diffused light is output;
a second substrate disposed to face the first substrate, a space being formed between the first and second substrates;
at least one partition disposed between the first and second substrates, the space being regionally divided by the at least one partition;
a sealing member disposed between the first and second substrates to seal the space; and
a voltage applying part to provide the electric signal to excite the discharge gas in the space.

4. The surface light source device of claim 3, wherein a sealing layer is formed between the at least one partition and the first substrate so that the space is sealed at a contact area between the at least one partition and the first substrate.

5. The surface light source device of claim 3, wherein a first sealing layer is formed between the sealing member and the first substrate, and a second sealing layer is formed between the sealing member and the second substrate.

6. The surface light source device of claim 3, wherein the space is defined by surfaces of the first and second substrates, the at least one partition and the sealing member, the surfaces are coated with a fluorescent layer.

7. The surface light source device of claim 6, wherein the surfaces of the first and second substrates have areas in contact with the at least one partition and remaining areas not in contact with the at least one partition, the fluorescent layer being formed on the remaining areas of the surfaces of the first and second substrates.

8. The surface light source device of claim 7, wherein the fluorescent layer is formed on the surfaces of the at least one partition which include a surface in contact with the sealing layer.

9. The surface light source device of claim 8, further including a light reflecting layer formed between the fluorescent layer and the surfaces of the second substrate and the least one partition.

10. The surface light source device of claim 9, wherein the light reflecting layer is made of material including aluminum oxide (Al₂O₃) or titanium oxide (TiO₃).

11. The surface light source device of claim 3, wherein the at least one partition includes two or more partitions having a substantially identical length smaller than a distance between opposite ends of the space in a longitudinal direction of the partitions.

12. The surface light source device of claim 11, wherein the partitions each have first and second end portions opposite to each other in the longitudinal direction, the partitions being in contact with the sealing member such that the first end portions of odd-numbered ones of the partitions are in contact with the sealing member and the second end portions of even-numbered ones of the partitions are in contact with the sealing member to partition the space in a serpentine form.

13. The surface light source device of claim 11, wherein the partitions are arranged in a direction substantially perpendicular to the longitudinal direction of the partitions and substantially parallel with each other.

14. The surface light source device of claim 2, wherein the light diffusion part includes a light diffusion pattern formed on a surface of the first substrate to diffuse the light generated from the light source body.

15. The surface light source device of claim 14, wherein, the first substrate has first and second surfaces opposite to each other and the first surface is in contact with the space and the at least one partition, the light diffusion pattern including a plurality of convex surfaces successively formed on the second surface.

16. The surface light source device of claim 14, wherein the first substrate has first and second surfaces opposite to each other and the first surface is in contact with the space and the at least one partition, the light diffusion pattern including a plurality of convex members formed on the second surface such that density of the convex members is higher at a first area through which the light passes than at a second area adjacent to the at least one partition.

17. The surface light source device of claim 16, wherein the convex members at the first and second areas have a substantially identical size.

18. The surface light source device of claim 14, wherein the first substrate has first and second surfaces opposite to each other and the first surface is in contact with the space and the at least one partition, the light diffusion pattern including a plurality of convex members formed on the second surface such that the convex members have a larger size at an area adjacent to the at least one partition than at an area through which the light passes.

19. The surface light source device of claim 14, wherein the first substrate has first and second surfaces opposite to each other and the first surface is in contact with the space and the at least one partition, the light diffusion pattern including a plurality of convex surfaces successively formed on the first surface.

20. The surface light source device of claim 14, wherein the first substrate has first and second surfaces opposite to each other and the first surface is in contact with the space and the at least one partition, the light diffusion pattern including a plurality of convex surfaces successively formed on both the first and second surfaces.

21. The surface light source device of claim 14, wherein the first substrate has first and second surfaces opposite to each other and the first surface is in contact with the space and the at least one partition, the light diffusion pattern including a plurality of V-shaped grooves successively formed on the second surface.

22. The surface light source device of claim 21, wherein the V-shaped grooves each have a rough surface such that a plurality of convex surfaces successively formed on the surface of the respective V-shaped grooves.

23. The surface light source device of claim 14, wherein the first substrate has first and second surfaces opposite to each other and the first surface is in contact with the space and the at least one partition, the light diffusion pattern including a plurality of protrusion members discretely formed on the second surface, the protrusion members each having a cross-sectional view of a polygonal shape.

24. The surface light source device of claim 14, wherein the first substrate has first and second surfaces opposite to each other and the first surface is in contact with the space and the at least one partition, the light diffusion pattern including a plurality of grooves discretely formed on the second surface, the grooves each having a cross-sectional view of a polygonal shape.

25. The surface light source device of claim 2, wherein the light diffusion part includes a plurality of light diffusion members disposed on a surface of the first substrate through which the diffused light is output.

26. The surface light source device of claim 25, wherein the light diffusion members have a substantially identical size and are attached on the surface of the first substrate by adhesive.

27. The surface light source device of claim 25, wherein the light diffusion members have various sizes and are attached on the surface of the first substrate by adhesive.

28. The surface light source device of claim 25, wherein the light diffusion members have a substantially identical size and are securely held by a binder which is coated on the surface of the first substrate.

29. A display device displaying images in response to electrical signals externally provided, comprising:
a display panel to display the images;
a surface light source device to provide surface light to the display panel, the surface light source device including:
a light source body to generate light in response to an electric signal, the light source body having a space filled with a discharge gas to generate the light; and
a light diffusion part to diffuse the light generated from the light source body to output diffused light, wherein the light diffusion part is integrally formed with the light source body; and
a receiving container to receive and securely hold the display panel and the surface light source device.

30. The display device of claim 29, wherein the light source body comprises:
a first substrate through which the diffused light is output;
a second substrate disposed to face the first substrate, a space being formed between the first and second substrates;
at least one partition disposed between the first and second substrates, the space being regionally divided by the at least one partition;
a sealing member disposed between the first and second substrates to seal the space; and
a voltage applying part to provide the electric signal to excite the discharge gas in the space.

31. The display device of claim 30, further including:
a first a sealing layer formed between the at least one partition and the first substrate so that the space is sealed at a contact area between the at least one partition and the first substrate;
a second sealing layer formed between the sealing member and the first substrate; and
a third sealing layer formed between the sealing member and the second substrate.

32. The display device of claim 30, further including a fluorescent layer formed on surfaces of the first and second substrates, the at least one partition and the sealing member which define the space of the light source body.

33. The display device of claim 32, further including a light reflecting layer formed between the fluorescent layer and the surfaces of the second substrate and the least one partition.

34. The display device of claim 30, wherein the light diffusion part includes a light diffusion pattern formed on at least one surface of the first substrate to diffuse the light generated from the light source body.
